(19) United States
(12) Patent Application Publication
(10) Pub. No.: US 2008/0182154 A1
(43) Pub. Date: Jul. 31, 2008

(54) Coating Slurry for Cation-Conducting Polymer Composite Membrane, Method for Producing Cation-Conducting Polymer Composite Membrane Using the Coating Slurry, Membrane-Electrode Assembly, and Fuel Cell

(75) Inventors: Tae Kyoung KIM, Yongin-si (KR); Myeong Soon KANG, Suwon-si (KR); Yeong Suk CHOI, Suwon-si (KR); Hae Kyoung KIM, Seoul (KR); Won Mok LEE, Seoul (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/016,409

(22) Filed: Jan. 18, 2008

(30) Foreign Application Priority Data
Jan. 30, 2007 (KR) 2007-0009665

(51) Int. Cl. H01M 4/00; C09D 5/00; B05D 5/12

(52) U.S. Cl. 429/42; 521/28; 427/115

(57) ABSTRACT

Disclosed herein is a slurry-type coating solution for cation-conducting polymer composite membranes that is capable of producing cation-conducting polymer composite membranes with high ionic conductivity as well as low methanol permeability and low ohmic resistance when used in direct-methanol fuel cells, via pluralization of solvents and use of specific additives. The coating slurry comprises about 1 to about 10 parts by weight of a sulfonated clay, about 100 parts by weight of a cation exchange group-containing polymer, and a co-solvent consisting of a high-boiling point solvent with a boiling point of about 180 to about 250° C. and a low-boiling point solvent with a boiling point of about 100 to about 180° C.

### CROSS-REFERENCE TO RELATED APPLICATIONS

This non-provisional application claims priority under 35 USC Section 119 from Korean Patent Application No. 2007-0009665 filed Jan. 30, 2007, which is hereby incorporated by reference in its entirety.

### FIELD OF THE INVENTION

The present invention relates to a coating slurry for a cation-conducting polymer composite membrane, a method for producing a cation-conducting polymer composite membrane using the coating solution, a membrane-electrode assembly and a fuel cell.

### BACKGROUND OF THE INVENTION

A fuel cell is an electrochemical device which directly converts chemical energy of hydrogen (H₂) and oxygen (O₂) into electric energy.

In a fuel cell, a cation-conducting polymer membrane allows hydrogen ions (6H⁺) generated in a catalyst layer of an anode (a negative electrode) to flow into a cathode (a positive electrode) and prevents crossover of external supplies of fuel (e.g., direct methanol fuel cells: methanol, H₂O, other fuel cells: H₂) from the anode to the cathode.

A membrane-electrode assembly of a fuel cell in which hydrogen ions and electrons are generated and reactions with oxygen occur must exhibit superior performance so that the practical values of the fuel cell are as close as possible to the theoretical values of direct-methanol fuel cells.

In particular, the function of cation-conducting polymer membranes that deliver hydrogen ions from the anode to the cathode is considerably important.

A membrane-electrode assembly composed of a polymer membrane which exhibits superior hydrogen ions-delivering capability (i.e., a high ionic conductivity) has a decreased ohmic resistance, thus resulting in a high power density.

In addition, polymer membranes have various functions. In direct methanol fuel cells, polymer membranes prevent crossover of methanol from the anode to the cathode. In polymer electrolyte fuel cells, polymer membranes prevent crossover of fuels (hydrogen or other gases modifiable into hydrogen) from the anode to the cathode.

When fuels permeate from the anode to the cathode through the polymer membrane, oxidation reactions of the fuels occur on the two electrodes, thus leading to a decrease in a reaction potential due to a reverse potential across the two electrodes. As a result, power densities of fuel cells are decreased.

In conventional cases, silica or clay inorganic particles were dispersed in polymers to reduce methanol permeability of cation-conducting polymer membranes, and furthermore, an organized silica or clay was used to improve dispersability of the membranes.

In addition, to prevent a decrease in ionic conductivity which results from the addition of inorganic particles with no ionic conductivity, a method for producing a polymer membrane by dispersing a sulfonated-clay containing sulfonic acid in polymers has been developed.

These conventional methods generally use a simple batch process to produce polymer membranes and examples thereof include: solution casting wherein a glass- or teflon tray is filled with a low-viscous solution and dried for a long period; casting of a coating solution on a glass substrate; and hot-pressing of polymers with a hot press.

Accordingly, there is a need to develop a coating solution and a process technique that are suitable for use in a continuous process employing a polymeric film material with high productivity.

### SUMMARY OF THE INVENTION

The present invention has been made to solve the foregoing problems of the prior art and it is one aspect of the present invention to provide a coating slurry for a cation-conducting polymer composite membrane which is suitable for use in film casting techniques, and exhibits superior ionic conductivity and good physical properties as well as low direct-permeability.

It is another aspect of the present invention to provide a method for producing a cation-conducting polymer composite membrane using the coating slurry.

It is yet another aspect of the present invention to provide a membrane-electrode assembly comprising the cation-conducting polymer composite membrane and a fuel cell comprising the membrane-electrode assembly.

In accordance with one aspect of the present invention, there is provided a coating slurry for a cation-conducting polymer composite membrane comprising: about 1 to about 10 parts by weight of a sulfonated clay; about 100 parts by weight of a cation exchange group-containing polymer; and a co-solvent comprising a high-boiling point solvent with a boiling point of about 180 to about 250° C. and a low-boiling point solvent with a boiling point of about 100 to about 180° C. in a weight ratio of about 1:20 to about 1:1.5.

In accordance with another aspect of the present invention, there is provided a method for producing a cation-conducting polymer composite membrane comprising: coating the coating slurry on one side of a polymer film to form a coating film; subjecting the coating film to primary-drying to primarily remove the low-boiling point solvent contained in the coating film; and subjecting the coating film to secondary-drying to primarily remove the high-boiling point solvent contained in the coating film.

In accordance with another aspect of the present invention, there is provided a membrane-electrode assembly comprising: a cation-conducting polymer composite membrane produced by the method; catalyst layers each coated or bonded onto both sides of the cation-conducting polymer composite membrane; and gas diffusion layers each arranged on the catalyst layers.

In accordance with yet another aspect of the present invention, there is provided a fuel cell comprising: the membrane-electrode assembly; and bipolar plates.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating a method for producing a cation-conducting polymer composite membrane using the coating slurry by film casting;

FIG. 2 is a schematic view illustrating film casting equipment used to produce a cation-conducting polymer composite membrane using the coating slurry;

FIG. 3 is a cross-sectional view schematically illustrating a membrane-electrode assembly (MEA) produced using the cation-conducting polymer composite membrane produced by the method;

FIG. 4 is an exploded perspective view schematically illustrating a fuel cell comprising the membrane-electrode assembly; and

FIG. 5 is a graph showing performance evaluation results of a unit fuel cell of the membrane-electrode assemblies produced in Example 2 and Comparative Example 4.

### DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

In one aspect, the present invention is directed to a coating slurry for a cation-conducting polymer composite membrane comprising: about 1 to about 10 parts by weight of a sulfonated clay; about 100 parts by weight of a cation exchange group-containing polymer; and a co-solvent including a high-boiling point solvent having a boiling point of about 180 to about 250° C. and a low-boiling point solvent having a boiling point of about 100 to about 180° C. in a weight ratio of about 1:20 to about 1:1.5.

As mentioned above, the coating slurry for cation-conducting polymer composite membranes comprises a sulfonated clay, a cation exchange group-containing polymer and a co-solvent.

### <Cation Exchange Group-Containing Polymer>

The cation exchange group-containing polymer is used as a matrix in the production of polymer membranes and can include fluorine-based polymers comprising at least one side chain containing at least one cation exchange group, non-fluorine-based polymers (hydrocarbon-based polymers) comprising at least one side chain containing at least one cation exchange group, and mixtures thereof.

The hydrocarbon-based polymer is selected from polysulfone-based polymers, polyaryl ether sulfone-based polymers, polyphosphazene-based polymers, polyether ketone-based polymers, polyaryl ether ketone-based polymers, poly(phthalazinone ether ketone)-based polymers, polyimide-based polymers, polybenzimidazole-based polymers, acrylonitrile-butadiene-styrene (ABS)-based polymers, styrene-butadiene rubber (SBR)-based polymers, polystyrene-based polymers, polyolefin-based polymers, polycarbonate-based polymers, poly ethylene terephthalate (PET)-based polymers, poly ethylene naphthalate (PEN)-based polymers, acryl-based polymers and mixtures thereof. Specific examples of the fluorine-based polymer include Nafion (Dupont Corp.), Aciplex (Asahi Kasei Corp.), Flemion (Asahi Glass Corp.) and a Hyflon ion (Solvay Corp.).

The cation exchange group is at least one selected from a sulfonic acid group, a phosphonic acid group, a sulfuric acid group, a phosphoric acid group, a carboxylic acid group, a sulfonimide group, and mixtures thereof.

### <Sulfonated-Clay>

In fuel cells, clays are generally used to reduce methanol permeability of cation-conducting polymer membranes and improve mechanical properties thereof and are substantially evenly distributed in the cation exchange group-containing polymers.

The clay used in the present invention is a sulfonated clay.

The term “sulfonated clay” as used herein refers to a clay containing a sulfonic acid and the clay is at least one selected from montmorillonite (MMT), illite, kaolinite, vermiculite, smectite, hectorite, mica, bentonite, nontronite, saponite, zeolite, alumina, rutile, talc, and mixtures thereof.

A method for preparing the sulfonated clay from montmorillonite will be described in detail.

Montmorillonite (MMT) is treated with an aqueous sulfuric acid solution to convert “Na⁺-MMT” into “H⁺-MMT”, the H⁺-MMT is then treated with 3-mercaptopropyltrimethoxy silane (3-MPTMS) to allow thiol (—SH) to be grafted on the surface of the MMT, and the thiol is oxidized to produce sulfonic acid (—SO₃H).

Alternatively, 1-propane sultone may be used instead of the 3-MPTMS, to introduce sulfonic acid (—SO₃H) into MMT.

By adding the sulfonated clay thus prepared to the cation exchange group-containing polymer, methanol permeability of the cation-conducting polymer membrane can be efficiently reduced without causing great loss to the ionic conductivity.

The content of the sulfonated clay is about 1 to about 10 parts by weight, based on about 100 parts by weight of the cation exchange group-containing polymer.

That is, the content (based on weight) of the sulfonated clay is about 1 to about 10% by weight, based on the total weight of the cation exchange group-containing polymer and the sulfonated clay.

When the content of the sulfonated clay is less than about 1 part by weight, based on about 100 parts by weight of the cation exchange group-containing polymer, the amount of sulfonated clay dispersed in the polymer may be insufficient. As a result, the clay may be less effective in preventing methanol crossover due to high methanol permeability of the polymer membrane (greater than 70%), as compared to polymer membranes to which no sulfonated clay is added.

When the content of the sulfonated clay exceeds about 10 parts by weight, based on about 100 parts by weight of the cation exchange group-containing polymer, the sulfonated clay cannot be sufficiently dispersed in the polymers and is thus aggregated. As a result, methanol permeability is increased and ionic conductivity is gradually decreased.

Accordingly, advantageously the content of the sulfonated clay is within the range as defined above.

Polymer membranes which are produced from a mixture of about 1 to about 10 parts by weight of the sulfonated clay with the polymer exhibit improved mechanical properties, more specifically, an increased tensile strength (up to about 166%) and increased elongation ratio (up to about 133%), as compared to polymer membranes in which no sulfonated clay is used.

### <Co-Solvent>

The co-solvent comprises a high-boiling point solvent (a first solvent) and a low-boiling point solvent (a second solvent). The high-boiling point solvent has a boiling point of about 180 to about 250° C., and can be selected from N-methyl-2-pyrrolidinone (NMP), dimethyl sulfoxide (DMSO), ethylene glycol (EG) and a combination thereof.

The low-boiling point solvent has a boiling point of about 100 to about 180° C., and can be selected from N,N-dimethyl acetamide (DMAc), dimethylformamide (DMF), cyclopentanone, H₂O and a combination thereof.

In the present invention, the coating slurry employs a combination of two solvents rather than a single solvent (i.e., a high-boiling point solvent and a low-boiling point solvent) where the difference in boiling point between the solvents can be at least about 20 to about 50° C. The use of a single solvent can lead to sudden secession (deintercalation) at a temperature close to the boiling point of the solvent, thus causing defects (e.g., pores or cracks) to polymer membrane.

In addition, using a single high-boiling point solvent can be inconvenient because drying at an excessively high temperature for a long time is required to thoroughly dry the coating slurry. This can be one of the design-limiting factors because of the length of drying equipment.

Meanwhile, using a single low-boiling point solvent has advantages of low drying temperature and high drying speed, but the low-boiling point solvent is volatilized during a coating process prior to drying, thus causing variations in viscosity and concentration of the coating slurry.

Control over the mixing ratio of the high-boiling point solvent and the low-boiling point solvent enables control over the azeotropic point of the co-solvent. This control results in variations in the size and distribution of ion clusters delivering hydrogen ions (H⁺), thus enabling control over ionic conductivity and methanol permeability of final polymer composite membranes.

Accordingly, the high-boiling point solvent and the low-boiling point solvent are used within a range of appropriate mixing ratios (w/w), for example, about 1:20 to about 1:1.5.

As mentioned above, it can be useful to adjust the content (based on weight) of the low-boiling point solvent to be higher than that of the high-boiling point solvent. In this case, the high-boiling point solvent remains in the coating membrane and allows the viscosity of the coating membrane to be adjusted to a desired level upon deintercalation of a great volume of the low-boiling point solvent during primary-drying at a low temperature. Furthermore, the high-boiling point solvent enables deintercalation of the remaining high-boiling point solvent during secondary-drying at a high temperature, thereby reducing internal stress of final polymer composite membranes and thus obtaining a smooth uniform dense coating membrane.

As a result, high ionic conductivity can be maintained and methanol permeability can be reduced.

The content of co-solvent used in the coating slurry for cation-conducting polymer composite membranes depends on the type of solvents used. Regardless of the type of solvents, the co-solvent of the present invention is added within the content range as defined above in preparation of the coating slurry. The addition of the co-solvent within the range allows the viscosity of the final coating slurry to be within a range of about 1,000 to about 5,000 cps.

Accordingly, in a case where a high-boiling point solvent and a low-boiling point solvent whose boiling points are similar and whose viscosities are high are used, the content of co-solvent is low. On the other hand, when the two solvents whose viscosities are high are used, the content of co-solvent is high.

The viscosity of the coating slurry can be within a range of about 1,000 to about 5,000 cps. The adjustment of the viscosity within the range aims to allow the coating slurry to be coated to a uniform thickness on a polymer film during film casting or tape casting which is generally used to produce coating films, and furthermore, to prevent thickness non-uniformity of the coated film which results from the phenomenon in which the coated film fails to maintain its originally cast shape and flows down.

Specifically, when the viscosity of the coating slurry is lower than about 1,000 cPs, the coated film obtained by casting undergoes variation in width, thus causing the coating slurry to flow in the gravitation direction prior to introduction into drying equipment. On the other hand, when the coating slurry exceeds about 5,000 cPs, such an excessively large viscosity makes it difficult to use the coating slurry to produce coating films and limits an increase in a coating speed.

<Production of Cation-Conducting Polymer Composite Membrane from Coating Slurry>

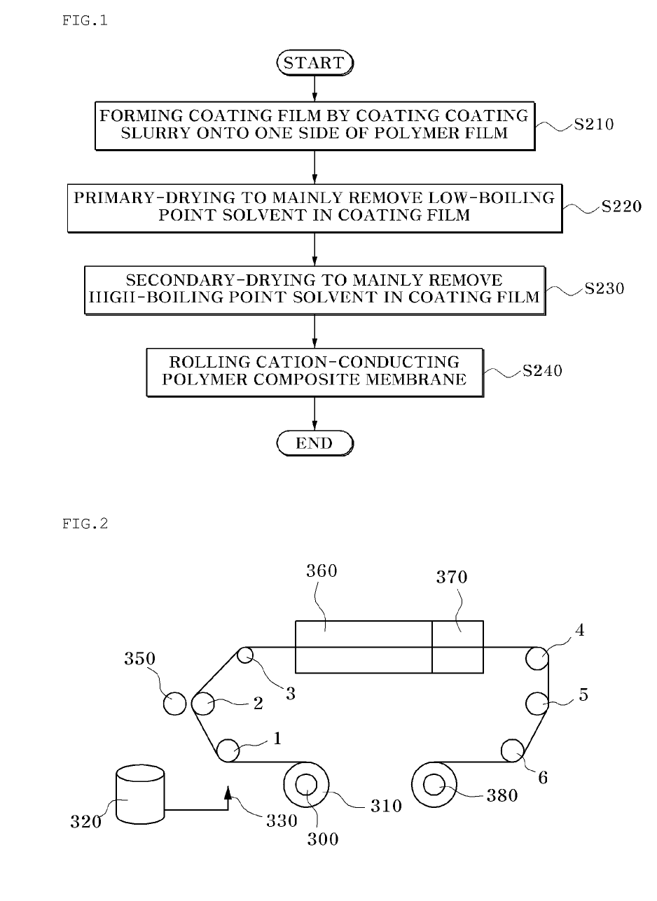

FIG. 1 is a flow chart illustrating a method for producing a cation-conducting polymer composite membrane using the coating slurry by film casting. FIG. 2 is a schematic view illustrating film casting equipment used to produce a cation-conducting polymer composite membrane from the coating slurry.

Hereinafter, an exemplary embodiment of a method for producing a coating film using the coating slurry with the use of film casting equipment will be described in detail. The present invention is not particularly limited to the exemplary embodiment. Alternatively, melting-extrusion or general coating techniques with the use of slurry-type coating solutions may be used.

To produce a cation-conducting polymer composite membrane using the coating slurry, first, at least one side of a polymer film is coated with a coating slurry to form a coating film (S210).

A polymer film 310 is rolled onto a base roll 300 and is released at a predetermined rate toward a coating die 330.

Subsequently, a predetermined amount of a coating slurry contained in a reservoir 320 flows into the coating die 330 and is coated to a thickness on at least one side of the polymer film 310 through the coating die 330 to form a coating film.

The polymer film 310 can be selected from poly(ethylene terephthalate) (PET)-based films, poly (ethylene naphthalate) (PEN)-based films, polycarbonate (PC)-based films, teflon-based films, polyimide-based films, polyolefin-based films, and films which are surface-treated with a release material. The polymer film 310 can have a thickness of about 50 to about 150 μm.

The coating die 330 may be of any coater and examples thereof include a die coater, comma coater, a blade coater and a gravure coater.

The thickness of the polymer film 310 must be within the range as defined above. The polymer film 310 with a thickness less than about 50 μm cannot endure tension by a coater roll during drying at high temperatures of about 100° C. or higher and may be thus broken, and meanwhile, the polymer film 310 with a thickness exceeding about 150 μm has disadvantages of high-cost and low runnability (production speed) of the coater.

The thickness of the coating film prior to drying formed on the polymer film 310 is not particularly limited, but can be in a range of about 10 μm to about 3 mm.

Then, the polymer film 310 where the coating film is formed is transferred into a hot air dryer 360 through guide rolls 1 and 2. If necessary, prior to the transference, the polymer film 310 may be passed through a metering roll 350 to obtain a uniform thickness.

In the hot air dryer 360, the polymer film 310 including the coating film is subjected to primary-drying so as to primarily remove the low-boiling point solvent contained in the coating film (S220).

In theory, the primary-drying aims to remove the low-boiling point solvent only. However, in practice, a part of the high-boiling point solvent as well as most of the low-boiling point solvent is removed during the primary-drying.

As such, after the primary-drying, a great volume of the low-boiling point solvent of co-solvent contained in the coating film is removed and the viscosity of the coating film is thus significantly increased.

Subsequently, the resulting polymer film 310 is subjected to secondary-drying at an internal temperature of the hot air drier 360 to be higher than the primary-drying temperature, such that the high-boiling point solvent is primarily removed (S230).

In theory, the secondary-drying aims to remove the high-boiling point solvent only. However, in practice, the remaining low-boiling point solvent as well as the most of the high-boiling point solvent is removed during the secondary-drying.

After completion of the drying processes, the coating film formed on the polymer film 310 is in a green solid-like sheet, not a liquid-phase.

By conducting UV drying (with a UV drier represented by “370”) following the hot air drying, the polymer matrix can be cross-linked through UV curable materials present in the coating film.

Cation-conducting polymer membranes for fuel cells are cast to a thickness of several micrometers to several millimeters. However, the length of drying equipment 360 involves design limitations. Accordingly, there is a need for restrictions between the length of drying equipment 360 and the line run rate of the polymer film to thoroughly dry the coating film.

As a result of repeated tests in accordance with the present invention, correlation between the length of drying equipment and the line run rate of the polymer film during the film casting is obtained as follows:

*drying equipment length(m)/line run rate(m/min)=about 2 to about 20

When the ratio is smaller than about 2, a line run rate is excessively high, when compared to the length of drying equipment. For this reason, an excessive amount of solvents may remain in the coating film. On the other hand, when the ratio is greater than about 20, the polymer film suffers from tension by the roll for a long time in the high-temperature drying equipment and may be thus broken.

Then, the coating film on the dried coating polymer film is rolled with the use of a roller 380 (S240).

At this time, the coating film coated on the polymer film may be rolled without conducting any process. Alternatively, the coating film only (i.e., cation-conducting polymer composite membrane) which is previously separated from the polymer film may be rolled.

In the film casting, the polymer film 310 is sequentially transferred to the following elements: a base roller 300-> a coating die 330-> a metering roll 350-> drying equipment 360-> a roller 380. Guide rolls (reference numerals represented by “1 to 6” in FIG. 2) arranged between the elements act as guides, allowing the polymer film 310 to efficiently transfer from one element to the other element. The arrangements and number of the guide rolls may vary depending on the design of the film casting equipment.

### <Membrane-Electrode Assembly and Fuel Cell>

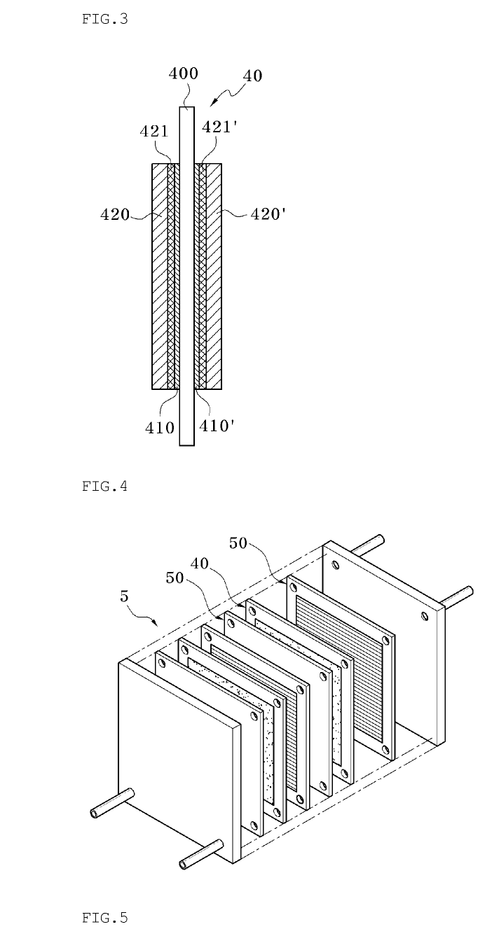

FIG. 3 is a cross-sectional view schematically illustrating a membrane-electrode assembly (MEA) produced using the cation-conducting polymer composite membrane produced by the method.

Referring to FIG. 3, the membrane-electrode assembly 40 of the present invention comprises a cation-conducting polymer composite membrane 400, catalyst layers 410 and 410′ each arranged on the both sides of the cation-conducting polymer composite membrane 400, and gas diffusion layers 420 and 420′ each arranged on the catalyst layers 410 and 410′.

The catalyst layers 410 and 410′ each can be composed of at least one catalyst selected from platinum (Pt), ruthenium (Ru), osmium (Os), a platinum-ruthenium alloy, a platinum-osmium alloy, a platinum-palladium alloy, and a platinum-M alloy (in which M is at least one transition metal selected from the group consisting of Ga, Ti, V, Cr, Mn, Fe, Co, Ni, Cu and Zn).

The catalyst may be used alone or in combination with carbon black. Alternatively, the catalyst may be in a catalyst-containing carbon carrier.

A slurry for the catalyst layers is prepared by dispersing the catalyst in cation-conducting polymers (ionomers).

Gas diffusion layers (GDL) 420 and 420′ are each arranged on the catalyst layers 410 and 410′.

The gas diffusion layers 420 and 420′ allow external supplies of fuels (methanol or hydrogen) and an oxygen gas to be efficiently transferred into the catalyst layers 410 and 410′, thereby promoting formation of a three-phase interface of catalyst-electrolyte membrane-gas. The gas diffusion layers 420 and 420′ can be composed of a carbon paper or a carbon cloth.

To promote diffusion of fuel and oxygen gases between the gas diffusion layers 420 and 420′ and the catalyst layers 410 and 410′, the membrane-electrode assembly 40 may further comprise microporous layers (MPL) 421 and 421′ interposed between the catalyst layers 410 and 410′ and the gas diffusion layers 420 and 420′, respectively.

FIG. 4 is an exploded perspective view schematically illustrating a fuel cell comprising the membrane-electrode assembly.

Referring to FIG. 4, the fuel cell 5 of the present invention comprises the membrane-electrode assembly 40 and bipolar plates 50 each arranged on both sides of the membrane-electrode assembly 40.

Hereinafter, the fact that the coating slurry for cation-conducting polymer composite membranes and the polymer composite membrane produced using the coating slurry by the method according to exemplary embodiments of the present invention exhibit low methanol permeability and have superior ionic conductivity as well as good mechanical properties will be demonstrated from specific description with reference to the following Examples. These examples are not to be construed as limiting the scope of the invention.

### 1. EXAMPLES

### Example 1

A Nafion dispersion (EW 1100, Dupont, Corp.) is precipitated in a water-insoluble solvent and vacuum-dried, to exclusively obtain a polymer powder. 100 parts by weight of the Nafion polymer powder is dissolved in 220 parts by weight of a co-solvent consisting of NMP as a high-boiling point solvent and DMAc as a low-boiling point solvent in a weight ratio of 1:2.3, to prepare a Nafion solution (concentration: 31.7 wt %).

2 parts by weight of sulfonated montmorillonite (sMMT) is dispersed in the Nafion solution, to prepare a coating slurry for a cation-conducting polymer composite membrane.

The coating slurry is film-cast on a 100 um PET film with the use of a die-coater and the solvent is removed in hot air drying equipment at 100 to 150° C. for 8 minutes, to form a cation-conducting polymer composite membrane with a thickness of 80 μm.

Further, the polymer composite membrane is vacuum-dried at 120° C. for 24 hours to remove the remaining solvent, the resulting polymer membrane is dipped in an aqueous 1M sulfuric acid solution, allowed to stand at 95° C. for 2 hours, and washed with deionized water (acid-treatment), to complete production of the cation-conducting polymer composite membrane. The polymer composite membrane is evaluated in accordance with the following manner. The results are set forth in Table 1.

### Example 2

A cation-conducting polymer composite membrane is produced in the same manner as in Example 1, except that 220 parts by weight of the co-solvent consisting of NMP and DMAc are used in a weight ratio of 1:9 and 5 parts by weight of sMMT is dissolved.

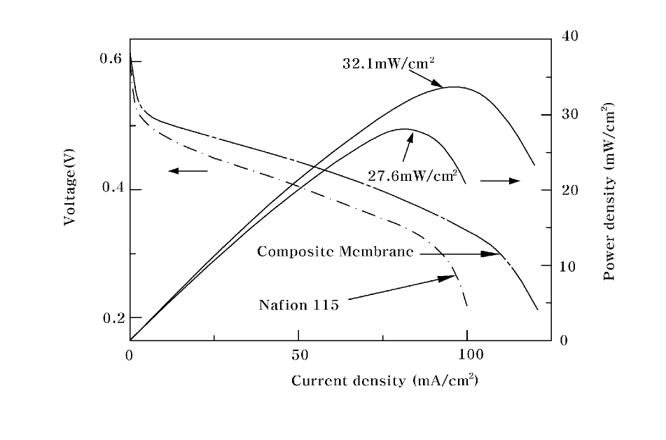

A membrane-electrode assembly is produced using the polymer composite membrane. Then, performance is evaluated for unit fuel cells of the membrane-electrode assembly in accordance with evaluation methods as below. The results are shown in Table 1 and FIG. 5.

### Example 3

A cation-conducting polymer composite membrane is produced in the same manner as in Example 1, except that 245 parts by weight of the co-solvent consisting of NMP and DMAc are used in a weight ratio of 1:9.

### Comparative Example 1

A cation-conducting polymer composite membrane is produced in the same manner as in Example 1, except that DMAc only is used as a solvent, instead of the co-solvent.

### Comparative Example 2

A cation-conducting polymer composite membrane is produced in the same manner as in Example 1, except that NMP only is used as a solvent, instead of the co-solvent.

### Comparative Example 3

A cation-conducting polymer composite membrane is produced in the same manner as in Example 1, except that the Nafion solution does not contain sMMT.

### Comparative Example 4

A cation-conducting polymer composite membrane is produced in the same manner as in Example 2, except that Nafion 115 (N 115, available commercially from Dupont Corp.) is used as a cation-conducting polymer composite membrane.

### 2. EVALUATION FOR PHYSICAL PROPERTIES AND PERFORMANCE OF UNIT CELLS

(1) Methanol Permeability

A diffusion cell consisting of a water-reservoir and a 3M MeOH reservoir is used to measure methanol permeability. Variation in molar concentration per unit time (dC/dt) at ambient temperature is measured for MeOH which diffuses from the MeOH reservoir to the water-reservoir. Methanol permeability (P) is calculated from the following Equation (I). At this time, an initial molar concentration of the MeOH reservoir is 3M.

P=(ΔC_{B}/Δt)(1/C_{Ai})(L/A)V_{B} (I)

wherein ΔC_{B}/Δt is variation in molar concentration per unit time; C_{Ai} is an initial molar concentration of a MeOH reservoir; L is a membrane thickness; A is a membrane area; and V_{B} is a volume of a water reservoir.

(2) Ionic Conductivity

After unit cells are dipped in deionized water in accordance with a 4-point probe method, the ionic conductivity of the cells is measured with an impedance analyzer at ambient temperature. The values plotted on a real number axis in a complex plane correspond to resistance values of the cation-conducting polymer composite membrane. The ionic conductivity is calculated by Equation (II) below:

σ=(1/R)(L/A) (II)

wherein R is a resistance; A is a membrane area; and L is a distance between a working electrode (WE) for measuring potential and a counter electrode (CE).

(3) Mechanical Properties

The tensile strength of cation-conducting polymer membranes is measured with H5K-T UTM® (Tinius Olsen Testing Machine Co., Inc.). The specimens with a width of 5 mm and a length of 30 mm are prepared from the dried polymer membranes. The tensile testing is conducted under the conditions of a pulling speed of 50 mm/min and a distance between grips holding the specimen of 10 mm.

(4) Viscosity of Coating Slurry

The viscosity of coating slurries is measured at a shear rate of 0.1 to 10 sec⁻¹ with an AR-2000 Rheometer (available from TA Instrument Ltd.). A spindle used herein is a cone-shape spindle with a diameter of 60 mm and an inclination angle of 2 degrees. At this time, the temperature is maintained at 20° C.

(5) Evaluation for Performance of Unit Fuel Cells

An anode is prepared by spray coating a gas diffusion layer with a PtRu black catalyst (HiSpec 6000, Johnson Matthey) at 5 mg/cm². A cathode is prepared by spray coating a gas diffusion layer with a Pt black catalyst (HiSpec 1000, Johnson Matthey) at 5 mg/cm². The anode and cathode are hot-pressed together with the cation-conducting polymer membrane, to produce a membrane-electrode assembly (MEA).

The MEA thus fabricated is applied to semi-passive direct-methanol fuel cells (DMFC). The performance of the unit fuel cell is evaluated. Air is fed into the cathode under ambient atmosphere without using any equipment. 1M methanol is fed at a stoichiometry of 3 into the anode with the use of a microflow pump. The temperature of the unit cell is maintained at 30° C. The I-V curve and ohmic resistance at 0.35 V of the unit cell are obtained. The ohmic resistance is measured at a frequency of 1 kH with Hioki 3560 (HiTester).

TABLE 1

| | | | | Comp. | Comp. | Comp. | Comp. |
|---|---|---|---|---|---|---|---|
| | Ex. 1 | Ex. 2 | Ex. 3 | Ex. 1 | Ex. 2 | Ex. 3 | Ex. 4 |
| Nafion | 100 | 100 | 100 | 100 | 100 | 100 | Nafion |
| (parts by wt.) | | | | | | | 115 ® |
| sMMT | 2 | 5.3 | 5.3 | 5.3 | 5.3 | — | |
| (parts by wt.) | | | | | | | |
| NMP:DMAc | 1:2.3 | 1:9 | 1:9 | DMAc | NMP | 1:9 | |
| | | | | only | only | | |
| NMP + DMAc | 220 | 220 | 245 | 220 | 220 | 220 | |
| (parts by wt.) | | | | | | | |
| Concentration | 31.7 | 32.4 | 30.1 | 32.4 | 32.4 | 31.3 | |
| (wt %) | | | | | | | |
| Viscosity (cPs) | 1,300 | 2,160 | 1,020 | 14,000 | 2,440 | 800 | |
| Ionic | 0.096 | 0.093 | 0.092 | 0.085 | 0.086 | 0.104 | 0.093 |
| conductivity | | | | | | | |
| (S/cm) | | | | | | | |
| Methanol | 1.25 × 10⁻⁶ | 1.14 × 10⁻⁶ | 1.15 × 10⁻⁶ | 1.27 × 10⁻⁶ | 1.37 × 10⁻⁶ | 1.76 × 10⁻⁶ | 1.55 × 10⁻⁶ |
| permeability | | | | | | | |
| (cm²/sec) | | | | | | | |
| Tensile strength | 14.1 | 19.2 | 19.0 | 18.2 | 18.4 | 11.6 | 26 |
| (N/mm²) | | | | | | | |
| Elongation ratio | 280 | 308 | 310 | 295 | 290 | 231 | 261 |
| (%) | | | | | | | |
| Cell performance | — | 30 | — | — | — | — | 25 |
| (mW/cm²) | | | | | | | |
| Ohmic resistance | — | 35 | — | — | — | — | 48 |
| (mΩ) | | | | | | | |

As apparent from the foregoing, the coating slurry for cation-conducting polymer composite membranes and the cation-conducting polymer composite membrane produced using the coating slurry according to the present invention exhibit low methanol permeability and similar physical properties, as compared to Nafion 115 which is conventionally used in the art.

It can be confirmed from testing of ohmic resistance and power density that a fuel cell comprising a membrane-electrode assembly produced from the cation-conducting polymer composite membrane exhibits superior physical properties.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A coating slurry for a cation-conducting polymer composite membrane comprising:
about 1 to about 10 parts by weight of a sulfonated clay;
about 100 parts by weight of a cation exchange group-containing polymer; and
a co-solvent comprising a high-boiling point solvent with a boiling point of about 180 to about 250° C. and a low-boiling point solvent with a boiling point of about 100 to about 180° C.

2. The coating slurry for a cation-conducting polymer composite membrane according to claim 1, wherein the high-boiling point solvent and the low-boiling point solvent are used in a weight ratio of about 1:20 to about 1:1.5.

3. The coating slurry for a cation-conducting polymer composite membrane according to claim 1, wherein the coating slurry has a viscosity of about 1,000 to about 5,000 cps.

4. The coating slurry for a cation-conducting polymer composite membrane according to claim 1, wherein the cation exchange group-containing polymer is selected from fluorine-based polymers comprising at least one side chain comprising at least one cation exchange group, hydrocarbon-based polymers comprising at least one side chain comprising at least one cation exchange group, and mixtures thereof.

5. The coating slurry for a cation-conducting polymer composite membrane according to claim 4, wherein the hydrocarbon-based polymer comprising at least one side chain comprising at least one cation exchange group is selected from polysulfone-based polymers, polyaryl ether sulfone-based polymers, polyphosphazene-based polymers, polyether ketone-based polymers, polyaryl ether ketone-based polymers, poly(phthalazinone ether ketone)-based polymers, polyimide-based polymers, polybenzimidazole-based polymers, acrylonitrile-butadiene-styrene (ABS)-based polymers, styrene-butadiene rubber (SBR)-based polymers, polystyrene-based polymers, polyolefin-based polymers, polycarbonate-based polymers, poly ethylene terephthalate (PET)-based polymers, poly ethylene naphthalate (PEN)-based polymers, acryl-based polymers and mixtures thereof.

6. The coating slurry for a cation-conducting polymer composite membrane according to claim 1, wherein the cation exchange group is at least one selected from a sulfonic acid group, a phosphonic acid group, a sulfuric acid group, a phosphoric acid group, a carboxylic acid group and a sulfonimide group.

7. The coating slurry for a cation-conducting polymer composite membrane according to claim 1, wherein the sulfonated clay comprises a sulfonic acid and comprises at least one clay selected from montmorillonite (MMT), illite, kaolinite, vermiculite, smectite, hectorite, mica, bentonite, nontronite, saponite, zeolite, alumina, rutile, talc, and mixtures thereof.

8. The coating slurry for a cation-conducting polymer composite membrane according to claim 1, wherein the high-boiling point solvent comprises at least one solvent selected from N-methyl-2-pyrrolidinone (NMP), dimethyl sulfoxide (DMSO), ethylene glycol (EG), and mixtures thereof.

9. The coating slurry for a cation-conducting polymer composite membrane according to claim 1, wherein the low-boiling point solvent comprises at least one solvent selected from N,N-dimethyl acetamide (DMAc), dimethylformamide (DMF), cyclopentanone, H₂O, and mixtures thereof.

10. The coating slurry for a cation-conducting polymer composite membrane according to claim 1, comprising a fluorine-based polymer comprising at least one side chain comprising at least one cation exchange group, sulfonated montmorillonite, and a co-solvent comprising NMP as a high-boiling point solvent and DMAc as a low-boiling point solvent.

11. A method for producing a cation-conducting polymer composite membrane comprising:
coating a coating slurry comprising about 1 to about 10 parts by weight of a sulfonated clay; about 100 parts by weight of a cation exchange group-containing polymer; and a co-solvent comprising a high-boiling point solvent with a boiling point of about 180 to about 250° C. and a low-boiling point solvent with a boiling point of about 100 to about 180° C. on one side of a polymer film to form a coating film;
subjecting the coating film to primary-drying to primarily remove the low-boiling point solvent in the coating film; and
subjecting the coating film to secondary-drying to primarily remove the high-boiling point solvent in the coating film.

12. The method according to claim 11, wherein the coating step comprises doctor blade tape casting.

13. The method according to claim 11, wherein the polymer film is selected from poly(ethylene terephthalate) (PET)-based films, poly(ethylene naphthalate)(PEN)-based films, polycarbonate (PC)-based films, teflon-based films, polyimide-based films, polyolefin-based films, and films surface-treated with a release material.

14. The method according to claim 11, wherein the coating film has a thickness of about 10 μm to about 3 mm.

15. The method according to claim 11, wherein the coating film is produced with a coater selected from a die coater, comma coater, a blade coater and a gravure coater.

16. The method according to claim 11, further comprising:
rolling the coating film, after secondary-drying,
wherein the overall process is carried out under the conditions that a length (m) of drying equipment/a line run rate (m/min) of the polymer film is about 2 to about 20.

17. A cation-conducting polymer composite membrane comprising:
a film comprising sulfonated clay and a cation exchange group-containing polymer; and
a polymer film,
wherein the cation-conducting polymer composite membrane has an ionic conductivity of about 0.092 S/cm or higher and a methanol permeability of about 1.25 cm²/sec or lower.

18. A membrane-electrode assembly comprising:
a cation-conducting polymer composite membrane produced by the method according to claim 11;
catalyst layers each deposition-coated onto both sides of the cation-conducting polymer composite membrane; and
gas diffusion layers each arranged on the catalyst layers.

19. A fuel cell comprising:
a membrane-electrode assembly according to claim 18; and
a pair of bipolar plates each arranged on both sides of the membrane-electrode assembly.
